(19) United States
(12) Patent Application Publication
(10) Pub. No.: US 2014/0299453 A1
(43) Pub. Date: Oct. 9, 2014

(54) SWITCH DEVICE AND SWITCH BASE BODY THEREOF

(71) Applicant: DOLPHIN TECHNOLOGY CO., LTD., New Taipei City (TW)

(72) Inventor: Chia-Yu Yang, New Taipei City (TW)

(73) Assignee: DOLPHIN TECHNOLOGY CO., LTD., New Taipei City (TW)

(21) Appl. No.: 14/243,464

(22) Filed: Apr. 2, 2014

(30) Foreign Application Priority Data
Apr. 8, 2013 (TW) 102206281

(51) Int. Cl. H01H 3/36

(52) U.S. Cl. CPC H01H 3/36; H01H 2207/00
USPC 200/337

(57) ABSTRACT

A switch device includes an actuating element and a switch base body with a control part and a switch element therein. The control part links an actuating element through a connection line, regulating a conducting circuit in the switch element to be a closed or open circuit as per operation of the actuating element.

### BACKGROUND OF THE INVENTION

1. Field of the Invention

The present disclosure presents a switch device and a switch base body thereof, particularly a switch device and a switch base body thereof for indoor wiring.

2. Description of the Prior Art

FIG. 1 is a schematic view illustrating a conventional switch device installed in a conducting circuit. In practice, a conventional switch device 9 is a push switch or a wall switch, and a conducting circuit 7 includes a load 71 (e.g., fluorescent lamp) and a power source 73 (e.g., AC or DC power source). As such, the load 71, such as an illuminator, under a user's control will get out light via the conventional switch device 9.

However, the conventional switch device 9 provided with the conducting circuit 7 or the electrical wiring existing in the conducting circuit 7, each of which is made of raw materials, such as copper and iron, with their prices rising, increases costs or consumes more electric power.

### SUMMARY OF THE INVENTION

The present disclosure presents a switch device and a switch base body thereof to overcome the above issue.

A switch device provided in the present disclosure comprises an actuating element and a switch base body. The switch base body is provided with a control part and a switch element: the control part links the actuating element through a connection line, regulating a conducting circuit in the switch element to be a closed or open circuit as per operation of the actuating element.

In an embodiment of the present disclosure, the control part linking the connection line is attached to or detached from the switch element's push button, which regulates the conducting circuit to be a closed or open circuit, as per operation status of the actuating element.

In an embodiment of the present disclosure, the switch base body is a micro-switch and the switch element comprises a reset component which is used to resume the conducting circuit as an open circuit.

In an embodiment of the present disclosure, the connection line is a non-conductive connection line.

In an embodiment of the present disclosure, the connection line is made of nylon thread or fabric yam.

In an embodiment of the present disclosure, the actuating element is a push switch.

In an embodiment of the present disclosure, the actuating element further comprises an adjusting part which engages with the connection line via a pin joint and regulates the connection line's length between the actuating element and the control part.

A switch base body provided in the present disclosure comprises a control part and a switch element: the control part links an actuating element through a connection line, regulating a conducting circuit in the switch element to be a closed or open circuit as per operation of the actuating element.

In an embodiment of the present disclosure, the control part linking the connection line is attached to or detached from the switch element's push button, which regulates the conducting circuit to be a closed or open circuit, as per operation status of the actuating element.

In an embodiment of the present disclosure, the switch base body is a micro-switch, the connection line is a non-conductive connection line, and the switch element comprises a reset component which is used to resume the conducting circuit as an open circuit.

It can be seen from above descriptions that a switch device in the present disclosure depends on an actuating element to link a switch base body through a connection line and a switch base body comprises a control part and a switch element wherein the control part regulates a conducting circuit in the switch element to be a closed or open circuit as per operation of the actuating element and the actuating element is connected to the switch base body through a non-conductive connection line for cost down.

These features and advantages of the present invention will be fully understood and appreciated from the following detailed description of the accompanying Drawings.

### BRIEF DESCRIPTION OF THE DRAWINGS

FIG. 1 is a schematic view illustrating a conventional switch device provided with a conducting circuit;

FIG. 2A is a schematic view illustrating operation of a switch device in an embodiment;

FIG. 2B is a schematic view illustrating operation of a switch device illustrated in FIG. 2A in another embodiment;

FIG. 3 is a schematic view illustrating operation of a switch device in a further embodiment

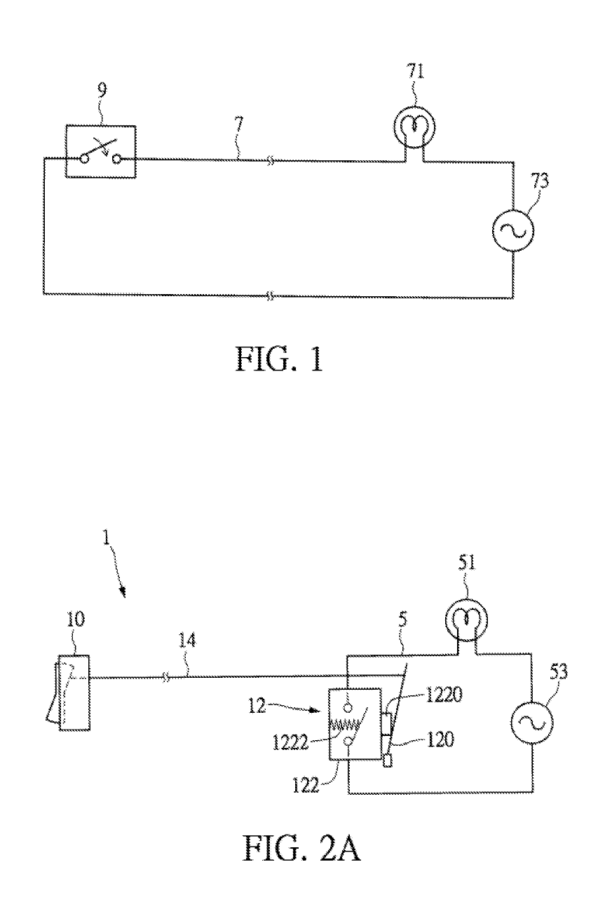

### DETAILED DESCRIPTION OF THE PREFERRED EMBODIMENT

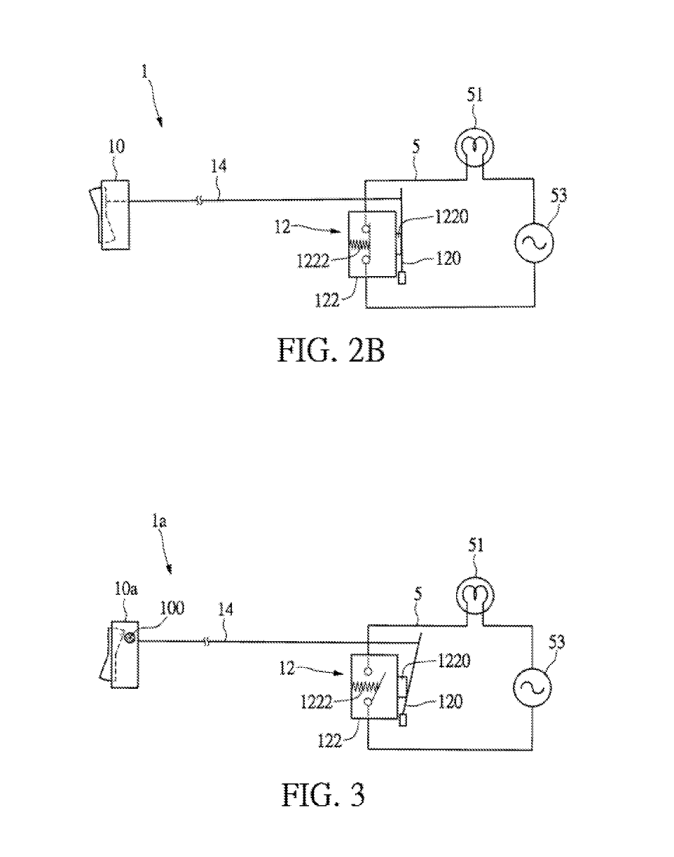

FIG. 2A is a schematic view illustrating operation of a switch device in an embodiment. Please refer to FIG. 2A. A switch device 1 includes an actuating element 10 and a switch base body 12. In practice, the actuating element 10 is a push switch which is installed on a wall or a housing of an electrical appliance, such as an illuminator or an electrical fan, and not limited to a specific model or position in the embodiment.

The switch base body 12 includes a control part 120 and a switch element 122. In practice, the switch base body 12 can be a micro-switch for example; the control part 120 which is connected between the switch element 122 and the actuating element 10 links the actuating element 10 through a connection line 14, regulating a conducting circuit 5 in the switch element 122 to be a closed or open circuit as per operation of the actuating element 10.

Specifically, the control part 120 depends on operation of the actuating element 10 to control the switch element 122; the switch element 122 regulates the conducting circuit 5 to be a closed or open circuit as per operation of the control part 120. As such, the switch base body 12 regulates the conducting circuit 5 to be a closed or open circuit by referring to operation of the actuating element 10.

The control part 120 with the connection line 14 joined depends on operation status of the actuating element 10 to be attached to or detached from a push button 1220 on the switch element 122, wherein the push button 1220 regulates the conducting circuit 5 to be a closed or open circuit. In practice, the control part 120, which can be a moveable handle linking the connection line 14, is attached to or detached from the push button 1220 on the switch element 122 when the actuating element 10 is activated by a user.

Furthermore, the switch element 122 includes a reset component 1222 which resumes the conducting circuit 5 as an open circuit. In practice, the reset component 122 can be a spring featuring retractility and elasticity, which resumes a stretched spring's original status with the control part 120 resisting the push button 1220 and enhances regulating the conducting circuit 5 to be a closed circuit because of the elasticity less than a resisting force applied on the push button 1220 by the control part 120. The control part 120, which is detached from the push button 1220, will regulate the conducting circuit 5 to be an open circuit with elasticity restoring a spring's original status released. In the embodiment, the reset component 1222 is not limited to a specific operation mode.

Moreover, the connection line 14 is a non-conductive connection line made of nylon thread or fabric yarn. In the embodiment, the connection line 14 is not limited to a specific connection line. In practice, a conventional switch device 9 links a load 71 and a power source 73 through a conductive connection line. However, the non-conductive connection line in the embodiment is used to link the actuating element 10 and the switch base body 12 so that a wiring path of the conducting circuit 5 linking the switch base body 12 and a load 51 or a power source 53 is curtailed with the switch base body 12 installed near the load 51 or the power source 53.

Furthermore, the switch device and the switch base body thereof in the present disclosure contribute to electric security because some accidents, such as electrical fire, short circuit or leakage current, that are attributed to overlap joints between the connection line 14 made of nylon thread or fabric yarn and the conducting circuit 5 or others do not occur in case of leakage current or water leakage indoors.

It can be seen from the present disclosure that the switch device and the switch base body thereof with the actuating element 10, the switch base body 12 and the connection line 14 integrated effectively function as the conventional switch device 9 and the non-conductive connection line between the actuating element 10 and the switch base body 12 reduces not only the length of the conductive connection line 14 in the conducting circuit 5 but also probability of short circuit at a conducting circuit 7 in the conventional switch device 9.

The operation of the switch device is further described as follows.

FIG. 2B is a schematic view illustrating operation of a switch device in FIG. 2A in another embodiment. Please refer to FIG. 2A and FIG. 2B. For the sake of clarity, the actuating element 10 and the load 51 in the embodiment are a push switch located at one position including, without limitation, a wall and an indoor illuminator, respectively.

For example, the status of the push switch on a wall is OFF when the actuating element 10 is not pressed by a user. At this point, the control part 120 linking the actuating element 10 through the connection line 14 but not contacting the push button 1220 of the switch element 122 regulates the conducting circuit 5 to be an open circuit by which the switch base body 12, the power source 53 and the load 51 is within an open loop without output of illumination from an indoor illuminator as shown in FIG. 2A.

On the other hand, the status of the push button on a wall is ON when the actuating element 10 is pressed by a user. At this point, the control part 120 depends on operation of the actuating element 10 to resist the push button 1220 on the switch element 122, regulating the conducting circuit 5 to be a closed circuit by which the switch base body 12, the power source 53 and the load 51 is within a closed loop with output of illumination from an indoor illuminator as shown in FIG. 2B.

Likewise, the status of the push switch on a wall is OFF when the actuating element 10 is pressed by a user again. At this point, the conducting circuit 5 resumes an open circuit when the control part 120 does not resist the push button 1220 and makes elasticity for restoring original status of the reset component 1222 released. In the embodiment, the switch device 1 is not limited to a specific operating mode.

FIG. 3 is a schematic view illustrating operation of a switch device in a further embodiment. Please refer to FIG. 3. In the embodiment, a switch device 1a, like the switch device 1 in the previous embodiment, depends on the control part 120 which is attached to or detached from the push button 1220 on the switch element 122, regulating the conducting circuit 5 in the switch element 122 to be a closed or open circuit. However, the switch device 1a, which is different from the switch device 1, features the actuating element 10 further including an adjusting part 100 that engages with the connection line 14 through a pin joint for an adjustable length of the connection line 14 between the actuating element 10 and the control part 120.

Specifically, the adjusting part 100 can be a component including, without limitation, an adjustable dial, an adjustable reel or an elastic reel. The stretched connection line 14, which does not follow fine-tuning of the actuating element 10 and makes the control part 120 uncontrollably attached to or detached from the push button 1220 on the switch element 122, will resume its proper length via the adjusting part 100. As such, the control part 120 is attached to or detached from the push button 1220 on the switch element 122 through the connection line 14 which depends on operation of the actuating element 10. Except for the difference hereinbefore, other technical features are realized by the person skilled in the art and referring to the previous embodiments and not repeatedly described herein.

In conclusion, the present disclosure presents a switch device comprising an actuating element and a switch base body with a control part and a switch element therein: the control part regulates a conducting circuit in the switch element to be a closed or open circuit as per operation of the actuating element and the actuating element is connected to the switch base body through a non-conductive connection line for the switch base body installed near a load or a power source and the cost down purpose.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A switch device, comprising: an actuating element and a switch base body with a control part and a switch element inside, wherein said control part links said actuating element through a connection line, regulating a conducting circuit in said switch element to be a closed or open circuit as per operation of said actuating element.

2. A switch device according to claim 1, wherein said control part linking said connection line is attached to or detached from said switch element's push button, which regulates said conducting circuit to be a closed or open circuit, as per operation status of said actuating element.

3. A switch device according to claim 2, wherein said switch base body is a micro-switch and said switch element comprises a reset component which is used to resume said conducting circuit as an open circuit.

4. A switch device according to claim 1, wherein said connection line is a non-conductive connection line.

5. A switch device according to claim 1, wherein said connection line is made of nylon thread or fabric yarn.

6. A switch device according to claim 1, wherein said actuating element is a push switch.

7. A switch device according to claim 1, wherein said actuating element further comprises an adjusting part which engages with said connection line through a pin joint and regulates said connection line's length between said actuating element and said control part.

8. A switch base body, comprising: a control part and a switch element, wherein said control part links an actuating element through a connection line, regulating a conducting circuit in said switch element to be a closed or open circuit as per operation of said actuating element.

9. A switch base body according to claim 8, wherein said control part linking said connection line is attached to or detached from said switch element's push button, which regulates said conducting circuit to be a closed or open circuit, as per operation status of said actuating element.

10. A switch base body according to claim 8, wherein said switch base body is a micro-switch, said connection line is a non-conductive connection line, and said switch element comprises a reset component which is used to resume said conducting circuit as an open circuit.

11. A switch device according to claim 3, wherein said connection line is a non-conductive connection line.

12. A switch device according to claim 3, wherein said connection line is made of nylon thread or fabric yarn.

13. A switch device according to claim 3, wherein said actuating element is a push switch.

14. A switch device according to claim 3, wherein said actuating element further comprises an adjusting part which engages with said connection line through a pin joint and regulates said connection line's length between said actuating element and said control part.

15. A switch base body according to claim 9, wherein said switch base body is a micro-switch, said connection line is a non-conductive connection line, and said switch element comprises a reset component which is used to resume said conducting circuit as an open circuit.
